(19) United States
(12) Patent Application Publication
(10) Pub. No.: US 2005/0289513 A1
(43) Pub. Date: Dec. 29, 2005

(54) Matrix pattern match techniques for uninstalling multiple dependent components

(75) Inventors: Paul Ming Chen, Markham (CA); Paul Darius Vytas, Toronto (CA)

Correspondence Address: International Business Machines;Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/870,222

(22) Filed: Jun. 17, 2004

(51) Int. Cl. G06F 9/44

(52) U.S. Cl. 717/121; 717/162; 717/170; 717/175

(57) ABSTRACT

There is disclosed a data processing system-implemented method, system and an article of manufacture for tracking software component dependencies among a set of multiple dependent software components of an application. In one aspect there is means for creating an n-dimensional matrix of predefined size in which is established a first dimension to represent the software components and a second dimension to represent the cross component dependencies. Next there is placed in each cell a value indicating an absence or a presence of a software component dependency within the set of multiple dependent software components of the application to create a software component dependency matrix. In a second aspect for uninstalling multiple dependent software components for a selected application from a computer system one then obtains the software component dependency matrix for the selected application. Next there is determined a candidate software component from the software component dependency matrix for removal. Next follows the process of uninstalling the candidate software component from the computer system and updating the software component dependency matrix to reflect removal of the candidate software component. The process of determining, uninstalling, and updating is repeated until all multiple dependent software components for the selected application have been uninstalled from the computer system.

### FIELD OF THE INVENTION

This present invention relates generally to managing software components and more particularly to uninstalling multiple dependent software components.

### BACKGROUND OF THE INVENTION

In the art of software component maintenance, components may typically be installed and uninstalled many times during the useful life cycle of the components. Typically there is a programming issue regarding the uninstall of multiple components in which the components may have a nested dependency with one another. When multiple components are uninstalled, the existing dependencies for the different components may prevent users from uninstalling those components due to their dependencies. For example, if a component is one component on which one or more other components depends, then that component cannot be uninstalled first since other components depend on it. In order to uninstall all components, users must first uninstall components which do not have any components depending on them. Typical mechanisms used to identify components that have no other components depending there from are tedious and difficult to program.

The following is a typical example of uninstalling software components using current techniques. Referring to FIG. 2, there are 6 components having the described relationships, Component A depends on Component B and Component C; Component D depends on Component A and Component B; Component F depends on Component B and Component C; Component E has no dependency.

One means of resolving the uninstall problem at a programming level may then be described as follows:

Step 1: Starting with Component A, determine if there are any components depending on Component A. Having found Component D depends on Component A, the process cannot uninstall Component A, and Component D dependencies if any then need to be reviewed.

Step 2: Investigate Component D to determine if there are any components depending on it. Having found no components depending on Component D, it can be uninstalled.

Step 3: Having successfully uninstalled Component D, loop back to component A and determine whether there are any components depending on Component A. The result is that there are no components depending on Component A after uninstalling Component D and therefore Component A is uninstalled.

Step 4: After successfully uninstalling Component A, continue by determining the status of Component B. It is then determined that Component F depends on the Component B and therefore Component B cannot be uninstalled without investigating Component F.

Step 5: A review of Component F, shows there are no components depending on it; therefore, Component F is uninstalled.

Step 6: Having successfully uninstalled Component F, loop back to Component B to determine if there are any components depending on Component B. Finding no components depending on Component B, Component B is then uninstalled.

Step 7: Having just uninstalled Component B, investigation continues with Component C. Since Components A and F have been uninstalled, there are no components depending on Component C, and the process can safely uninstall Component C.

Step 8: Component E remains, but there are no components depending on the Component E, so it is uninstalled to complete the exercise. In summary, the sequence of uninstalling these components is the following: D-->A-->F-->B-->C-->E. But Component E had been independent from the beginning.

One of the ways to program the algorithm used in the example would be to use a recursive method to examine all components in order to reach the base case. However, the recursive algorithm may only work if all components are connected to describe a dependency among them. If one or more components are not connected, a for-loop may be required in addition to the recursive routine to resolve the independent component as in example problem. Using a recursive routine plus a for-loop to resolve the simple type of problem stated in the example may prove to be slow and difficult to program. More complex requests to uninstall nested dependent software components will therefore require additional for-loops for each case of independent component and additional recursive logic.

It would therefore be highly desirable to have a method and software providing a more efficient manner to uninstall software components in cases of increasing complexity.

### SUMMARY OF THE INVENTION

Conveniently, software exemplary of an embodiment of the present invention may allow use of a matrix pattern match technique to resolve uninstall problems for multiple dependent components typically in a more expedient manner than before.

A component dependency matrix is created to describe the dependent relationship that exists between components, even those having no such dependency relationship. The matrix pattern match technique examines the pattern in the created dependency matrix based on all components. Typically a rapid determination may be made regarding which components have no other dependent components. Having found such components, they may then be quickly removed. For example, using components of FIG. 2 as before, the following dependency matrix table as shown in Table 1 of Appendix A, can be constructed to express the dependency relationships between the components in which a ‘0’ means no dependency and a ‘1’ means with dependency. The first row of Table 1 of Appendix A indicates that Component A depends on Component B and Component C. From Table 1, it may be seen that where one column has only ‘0s’, the associated Component (listed as the row title) has no other dependent components. For example, Component D, E, and F have only ‘0’ entries in their columns, and it means that D, E and F can be safely uninstalled.

In one embodiment of the present invention there is a data processing system-implemented method for tracking software component dependencies among a set of multiple dependent software components of an application, comprising: creating an n-dimensional matrix of predefined size; establishing a first dimension to represent software components and a second dimension to represent cross component dependencies; and placing a value in each cell indicating one of an absence and a presence of a software component dependency within the set of multiple dependent software components to create a software component dependency matrix.

In another embodiment of the present invention there is a data processing system-implemented method for uninstalling multiple dependent software components for a selected application from a computer system, comprising: obtaining a software component dependency matrix for the selected application; determining a candidate software component from the software component dependency matrix for removal; uninstalling the candidate software component from the computer system; updating the software component dependency matrix to reflect removal of the candidate software component; and repeating determining, uninstalling, and updating until all multiple dependent software components for the selected application have been uninstalled from the computer system.

In another embodiment of the present invention there is a data processing system for tracking software component dependencies among a set of multiple dependent software components of an application, comprising: a means for creating an n-dimensional matrix of predefined size; a means for establishing a first dimension to represent software components and a second dimension to represent cross component dependencies; and a means for placing a value in each cell indicating one of an absence and a presence of a software component dependency within the set of multiple dependent software components to create a software component dependency matrix.

In another embodiment of the present invention there is a data processing system for uninstalling multiple dependent software components for a selected application from the data processing system, comprising: a means for obtaining a software component dependency matrix for the selected application; a means for determining a candidate software component from the software component dependency matrix for removal; a means for uninstalling the candidate software component from the computer system; a means for updating the software component dependency matrix to reflect removal of the candidate software component; and a means for repeating determining, uninstalling, and updating until all multiple dependent software components for the selected application have been uninstalled from the computer system.

In another embodiment of the present invention there is an article of manufacture for directing a data processing system to track software component dependencies among a set of multiple dependent software components of an application, the article of manufacture comprising: a computer usable medium embodying one or more instructions executable by the data processing system, the one or more instructions comprising: data processing system executable instructions for creating an n-dimensional matrix of predefined size; data processing system executable instructions for establishing a first dimension to represent software components and a second dimension to represent cross component dependencies; and data processing system executable instructions for placing a value in each cell indicating one of an absence and a presence of a software component dependency within the set of multiple dependent software components to create a software component dependency matrix.

In another embodiment of the present invention there is an article of manufacture for directing a data processing system to uninstall multiple dependent software components for a selected application from the data processing system, the article of manufacture comprising: a computer usable medium embodying one or more instructions executable by the data processing system, the one or more instructions comprising: data processing system executable instructions for obtaining a software component dependency matrix for the selected application; data processing system executable instructions for determining a candidate software component from the software component dependency matrix for removal; data processing system executable instructions for uninstalling the candidate software component from the computer system; data processing system executable instructions for updating the software component dependency matrix to reflect removal of the candidate software component; and data processing system executable instructions for repeating determining, uninstalling, and updating until all multiple dependent software components for the selected application have been uninstalled from the computer system.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate embodiments of the present invention by example only,

FIG. 1 is a block diagram of a computer data processing system which may be used to incorporate an embodiment of the present invention;

FIG. 2 is a block diagram of an example of relationship dependencies among software components;

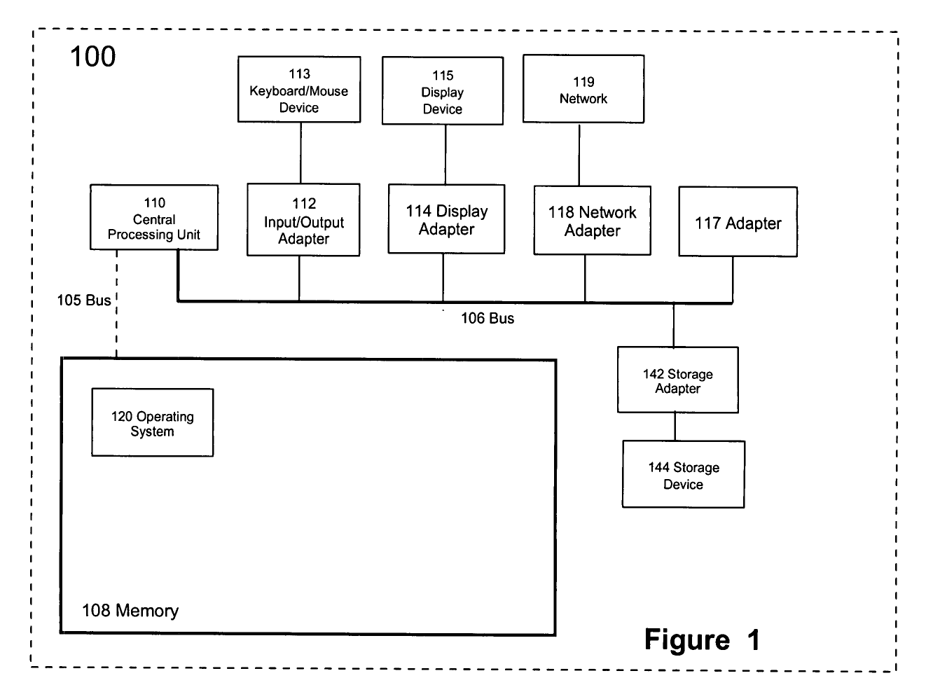

Tables 1 to 5 of Appendix A are tabular views of data representative of an implementation of an embodiment of the present invention which may be implemented within the system of FIG. 1.

Like reference numerals refer to corresponding components and steps throughout the drawings.

### DETAILED DESCRIPTION

FIG. 1 depicts, in a simplified block diagram, a computer system 100 suitable for implementing embodiments of the present invention. Computer system 100 has a central processing unit (CPU) 110, which is a programmable processor for executing programmed instructions 126 stored in memory 108. Memory 108 can also include hard disk, tape or other storage media. While a single CPU is depicted in FIG. 1, it is understood that other forms of computer systems can be used to implement the invention, including multiple CPUs. It is also appreciated that the present invention can be implemented in a distributed computing environment having a plurality of computers communicating via a suitable network 119, such as the Internet.

CPU 110 is connected to memory 108 either through a dedicated system bus 105 and/or a general system bus 106. Memory 108 can be a random access semiconductor memory for storing components of an embodiment of the present invention such as matrices or tables as will be described later. Memory 108 is depicted conceptually as a single monolithic entity but it is well known that memory 108 can be arranged in a hierarchy of caches and other memory devices. FIG. 1 illustrates that operating system 120, may reside in memory 108.

Operating system 120 provides functions such as device interfaces, memory management, multiple task management, and the like as known in the art. CPU 110 can be suitably programmed to read, load, and execute instructions of operating system 120. Computer system 100 has the necessary subsystems and functional components to implement support for embodiments of the present invention such as data structures as will be discussed later. Other programs (not shown) include server software applications in which network adapter 118 interacts with the server software application to enable computer system 100 to function as a network server via network 119.

General system bus 106 supports transfer of data, commands, and other information between various subsystems of computer system 100. While shown in simplified form as a single bus, bus 106 can be structured as multiple buses arranged in hierarchical form. Display adapter 114 supports video display device 115, which is a cathode-ray tube display or a display based upon other suitable display technology that may be used to depict results provided by an implementation of an embodiment of the present invention. The Input/output adapter 112 supports devices suited for input and output, such as keyboard or mouse device 113, and a disk drive unit (not shown). Storage adapter 142 supports one or more data storage devices 144, which could include a magnetic hard disk drive or CD-ROM drive although other types of data storage devices can be used, including removable media for storing data files which may be in tabular form, logging data and other information in support of an implementation of an embodiment of the present invention.

Adapter 117 is used for operationally connecting many types of peripheral computing devices to computer system 100 via bus 106, such as printers, bus adapters, and other computers using one or more protocols including Token Ring, LAN connections, as known in the art. Network adapter 118 provides a physical interface to a suitable network 119, such as the Internet. Network adapter 118 includes a modem that can be connected to a telephone line for accessing network 119. Computer system 100 can be connected to another network server via a local area network using an appropriate network protocol and the network server can in turn be connected to the Internet. FIG. 1 is intended as an exemplary representation of computer system 100 by which embodiments of the present invention can be implemented. It is understood that in other computer systems, many variations in system configuration are possible in addition to those mentioned here.

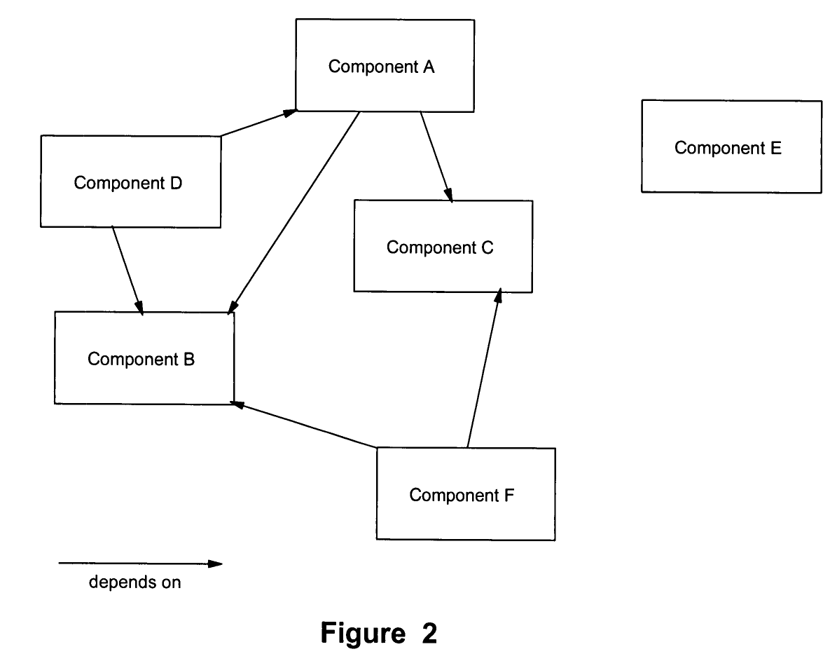

Using the example software component relationship dependencies as shown in FIG. 2 the steps of an uninstall in an embodiment of the present invention will now be described. First the construction of the component dependency matrix is performed to create a matrix as shown in Table 1 of Appendix A. The component dependency matrix may be created at any time. It may be advantageous to create the matrix during product installation or product update time. It may also be created just before use in the event of product uninstall.

Next, for each column, determine the list of the components that only have ‘0’ entries as the value in their respective column. Components having this characteristic will be the first to be removed and establishes the order of removal. Components D, E and F of Table 2 satisfy the requirement of only ‘0’ in their respective columns, indicating it is safe to uninstall now.

Next proceed to uninstall Components D, E and F. After the removal of D, E and F modify the rows for Component D, E, and F to be all ‘0s’ since the components have been uninstalled producing the matrix of Table 3. The rows and columns of data for Components D, E, and F have been ‘greyed’ out as they are no longer useful.

Next for each remaining column, determine the list of the components that only have the ‘0’ entries as the values in the column. It was determined that Component A satisfied the condition.

Next Component A was safely uninstalled. The row for Component A was then modified to contain all ‘0s’ as shown in the matrix below Table 4. As before data for rows and columns of Components A, has been ‘greyed’ out as it is are no longer useful.

Next, for each remaining column, determine the list of components having only ‘0s’ as values in the column. For this example Components B and C now meet the requirement.

Based on the result of the matrix analysis it was now safe to uninstall Component B and C. Since there are no more columns to process, all components have been successfully uninstalled in proper dependency order producing Table 5 in which data for all rows and columns have been ‘greyed’ out.

In summary, the sequence of uninstalling these components is the following: D-->E-->F-->A-->B-->C. The value of the method may be found in the ease of determining related dependencies and which component to process next. A quick scan of the table created in an embodiment of the present invention may show how many and which components may be quickly removed as having no dependencies. Recursive processing may then be reduced and for-loop processing eliminated. The process order differs from that of the recursive model shown earlier as the process determines the order of removal from the updated matrix. The new process may therefore allow components without dependencies to be removed earlier in the cycle than that of the recursive process used earlier. Dependencies are also updated after each pass of the matrix during processing. Recursive steps may be further reduced through fast table scans and one is able to readily track uninstall progress. With specific use of the dependency matrix one may also be able to perform selective uninstalls by stopping at a specific component. Additionally components can be prevented from being uninstalled by fixing a dependency on a component that is deemed uninstallable (mark the cell value as no update).

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

### APPENDIX A

TABLE 1

| | Component A | Component B | Component C | Component D | Component E | Component F |
|---|---|---|---|---|---|---|
| | (Dependency) | (Dependency) | (Dependency) | (Dependency) | (Dependency) | (Dependency) |
| Component A | 0 | 1 | 1 | 0 | 0 | 0 |
| Component B | 0 | 0 | 0 | 0 | 0 | 0 |
| Component C | 0 | 0 | 0 | 0 | 0 | 0 |
| Component D | 1 | 1 | 0 | 0 | 0 | 0 |
| Component E | 0 | 0 | 0 | 0 | 0 | 0 |
| Component F | 0 | 1 | 1 | 0 | 0 | 0 |

TABLE 2

| | Component A | Component B | Component C | Component D | Component E | Component F |
|---|---|---|---|---|---|---|
| | (Dependency) | (Dependency) | (Dependency) | (Dependency) | (Dependency) | (Dependency) |
| Component A | 0 | 1 | 1 | 0 | 0 | 0 |
| Component B | 0 | 0 | 0 | 0 | 0 | 0 |
| Component C | 0 | 0 | 0 | 0 | 0 | 0 |
| Component D | 1 | 1 | 0 | 0 | 0 | 0 |
| Component E | 0 | 0 | 0 | 0 | 0 | 0 |
| Component F | 0 | 1 | 1 | 0 | 0 | 0 |

TABLE 3

| | Component A | Component B | Component C | Component D | Component E | Component F |
|---|---|---|---|---|---|---|
| | (Dependency) | (Dependency) | (Dependency) | (Dependency) | (Dependency) | (Dependency) |
| Component A | 0 | 1 | 1 | [symbol] | [symbol] | [symbol] |
| Component B | 0 | 0 | 0 | [symbol] | [symbol] | [symbol] |
| Component C | 0 | 0 | 0 | [symbol] | [symbol] | [symbol] |
| Component D | [symbol] | [symbol] | [symbol] | [symbol] | [symbol] | [symbol] |
| Component E | [symbol] | [symbol] | [symbol] | [symbol] | [symbol] | [symbol] |
| Component F | [symbol] | [symbol] | [symbol] | [symbol] | [symbol] | [symbol] |

TABLE 4

| | Component A | Component B | Component C | Component D | Component E | Component F |
|---|---|---|---|---|---|---|
| | (Dependency) | (Dependency) | (Dependency) | (Dependency) | (Dependency) | (Dependency) |
| Component A | [symbol] | [symbol] | [symbol] | [symbol] | [symbol] | [symbol] |
| Component B | [symbol] | 0 | 0 | [symbol] | [symbol] | [symbol] |
| Component C | [symbol] | 0 | 0 | [symbol] | [symbol] | [symbol] |
| Component D | [symbol] | [symbol] | [symbol] | [symbol] | [symbol] | [symbol] |
| Component E | [symbol] | [symbol] | [symbol] | [symbol] | [symbol] | [symbol] |
| Component F | [symbol] | [symbol] | [symbol] | [symbol] | [symbol] | [symbol] |

TABLE 5

| | Component A | Component B | Component C | Component D | Component E | Component F |
|---|---|---|---|---|---|---|
| | (Dependency) | (Dependency) | (Dependency) | (Dependency) | (Dependency) | (Dependency) |
| Component A | [symbol] | [symbol] | [symbol] | [symbol] | [symbol] | [symbol] |
| Component B | [symbol] | [symbol] | [symbol] | [symbol] | [symbol] | [symbol] |
| Component C | [symbol] | [symbol] | [symbol] | [symbol] | [symbol] | [symbol] |
| Component D | [symbol] | [symbol] | [symbol] | [symbol] | [symbol] | [symbol] |
| Component E | [symbol] | [symbol] | [symbol] | [symbol] | [symbol] | [symbol] |
| Component F | [symbol] | [symbol] | [symbol] | [symbol] | [symbol] | [symbol] |

1. A data processing system-implemented method for tracking software component dependencies among a set of multiple dependent software components of an application, comprising:
creating an n-dimensional matrix of predefined size;
establishing a first dimension to represent software components and a second dimension to represent cross component dependencies; and
placing a value in each cell indicating one of an absence and a presence of a software component dependency within the set of multiple dependent software components to create a software component dependency matrix.

2. The data processing system-implemented method of claim 1 wherein the first dimension is a plurality of rows representing the software components and the second dimension is a plurality of columns representing the software component dependencies.

3. The data processing system-implemented method of claim 1 wherein the n-dimensional matrix is a relational database table.

4. The data processing system-implemented method of claim 1 wherein each cell of the software component dependency matrix contains one of a first value and a second value.

5. The data processing system-implemented method of claim 4 wherein the first value is a zero indicating absence of a software component dependency and the second value indicating presence of a software component dependency for a respective pair of software components.

6. The data processing system-implemented method of claim 1 being performed prior to uninstalling software components.

7. The data processing system-implemented method of claim 1 wherein the predefined size is dimensioned to contain the set of software components.

8. A data processing system-implemented method for uninstalling multiple dependent software components for a selected application from a computer system, comprising:
obtaining a software component dependency matrix for the selected application;
determining a candidate software component from the software component dependency matrix for removal;
uninstalling the candidate software component from the computer system;
updating the software component dependency matrix to reflect removal of the candidate software component; and
repeating determining, uninstalling, and updating until all multiple dependent software components for the selected application have been uninstalled from the computer system.

9. The data processing system-implemented method of claim 8 wherein updating the software component dependency matrix further comprises setting all cells in a row corresponding to the uninstalled software component to zero.

10. The data processing system-implemented method of claim 8 wherein establishing a candidate software component comprises determining the candidate software component having its respective column contain all zeroes.

11. A data processing system for tracking software component dependencies among a set of multiple dependent software components of an application, comprising:
a means for creating an n-dimensional matrix of predefined size;
a means for establishing a first dimension to represent software components and a second dimension to represent cross component dependencies; and
a means for placing a value in each cell indicating one of an absence and a presence of a software component dependency within the set of multiple dependent software components to create a software component dependency matrix.

12. The data processing system of claim 11 wherein the first dimension is a plurality of rows representing the software components and the second dimension is a plurality of columns representing the software component dependencies.

13. The data processing system of claim 11 wherein the n-dimensional matrix is a relational database table.

14. The data processing system of claim 11 wherein each cell of the software component dependency matrix contains one of a first value and a second value.

15. The data processing system of claim 14 wherein the first value is a zero indicating absence of a software component dependency and the second value indicating presence of a software component dependency for a respective pair of software components.

16. A data processing system for uninstalling multiple dependent software components for a selected application from the data processing system, comprising:
a means for obtaining a software component dependency matrix for the selected application;
a means for determining a candidate software component from the software component dependency matrix for removal;
a means for uninstalling the candidate software component from the computer system;
a means for updating the software component dependency matrix to reflect removal of the candidate software component; and
a means for repeating determining, uninstalling, and updating until all multiple dependent software components for the selected application have been uninstalled from the computer system.

17. The data processing system of claim 16 wherein the means for updating the software component dependency matrix further comprises means for setting all cells in a row corresponding to the uninstalled software component to zero.

18. The data processing system of claim 16 wherein the means for establishing a candidate software component comprises means for determining the candidate software component having its respective column contain all zeroes.

19. An article of manufacture for directing a data processing system to track software component dependencies among a set of multiple dependent software components of an application, the article of manufacture comprising:
a computer usable medium embodying one or more instructions executable by the data processing system, the one or more instructions comprising:
data processing system executable instructions for creating an n-dimensional matrix of predefined size;
data processing system executable instructions for establishing a first dimension to represent software components and a second dimension to represent cross component dependencies; and
data processing system executable instructions for placing a value in each cell indicating one of an absence and a presence of a software component dependency within the set of multiple dependent software components to create a software component dependency matrix.

20. The article of manufacture of claim 19 wherein the first dimension is a plurality of rows representing the software components and the second dimension is a plurality of columns representing the software component dependencies.

21. The article of manufacture of claim 19 wherein the n-dimensional matrix is a relational database table.

22. The article of manufacture of claim 19 wherein each cell of the software component dependency matrix contains one of a first value and a second value.

23. The article of manufacture of claim 19 wherein the first value is a zero indicating absence of a software component dependency and the second value indicating presence of a software component dependency for a respective pair of software components.

24. An article of manufacture for directing a data processing system to uninstall multiple dependent software components for a selected application from the data processing system, the article of manufacture comprising:
a computer usable medium embodying one or more instructions executable by the data processing system, the one or more instructions comprising:
data processing system executable instructions for obtaining a software component dependency matrix for the selected application;
data processing system executable instructions for determining a candidate software component from the software component dependency matrix for removal;
data processing system executable instructions for uninstalling the candidate software component from the computer system;
data processing system executable instructions for updating the software component dependency matrix to reflect removal of the candidate software component; and
data processing system executable instructions for repeating determining, uninstalling, and updating until all multiple dependent software components for the selected application have been uninstalled from the computer system.

25. The article of manufacture of claim 24 wherein the data processing system executable instructions for updating the software component dependency matrix further comprises data processing system executable instructions for setting all cells in a row corresponding to the uninstalled software component to zero.

26. The article of manufacture of claim 24 wherein the data processing system executable instructions for establishing a candidate software component comprises data processing system executable instructions for determining the candidate software component having its respective column contain all zeroes.
